(19) United States
(12) Patent Application Publication
(10) Pub. No.: US 2014/0008156 A1
(43) Pub. Date: Jan. 9, 2014

(54) LIFT DOOR WITH A DOOR PANEL GUIDE

(71) Applicant: Barry Umbaugh, Gettysburg, PA (US)

(72) Inventor: Barry Umbaugh, Gettysburg, PA (US)

(21) Appl. No.: 13/541,083

(22) Filed: Jul. 3, 2012

(51) Int. Cl. B66B 13/08

(52) U.S. Cl. 187/313

(57) ABSTRACT

An elevator door has a door sill, including a guide groove with two mutually spaced side walls, and a door panel which is movable along the guide groove and at the door panel termination of which facing the door sill a guide shoe entering the guide groove is arranged, wherein the guide shoe is arranged at the first end of the door panel termination facing the door opening when the elevator door is open and the side walls of the door sill are formed as guide surfaces for the guide shoe. The door panel has at the door panel termination a guide straight edge extending along the door panel termination and the door sill has a guide body, wherein the guide body forms at least one guide surface for guidance of the guide straight edge.

### FIELD

The invention relates to a lift or elevator door with a door panel and with a door sill, wherein the door panel is guided at the door sill.

### BACKGROUND

Known elevator installations comprise elevator doors, which are arranged at floors or at an elevator car. Such elevator doors have door panels which are suspended and driven in the region of the upper edge thereof. The elevator doors also have door sills. The door sill represents a tread region in the area of the door opening. In addition, the door panel is usually guided at this door sill. For this purpose a guide groove into which at least one guide element attached to the door panel enters is arranged in the door sill. During an opening or closing movement of the door panel the guide element slides within this guide groove provided therefor. In this way it can always be ensured that the door panel maintains its preferably vertical alignment even if, for example, a person leans against the door panel.

EP 1646576 shows an elevator door comprising a door panel and a door sill. Guide shoes are attached to the lower edge of the door panel. The door sill has a guide groove. The guide shoes enter into the guide groove in such a manner that the door panel is guided and mounted by means of the guide groove.

It is problematic with such a construction that the guide groove of the door sill has to go beyond the door opening width to a significant extent in order to be able to guide the door panel up to the point of complete opening thereof. In that case, not only an increased need for material for the door sill, but also a greater need of space for transport of the door sill to a place of installation are a disadvantage.

### SUMMARY

It is therefore the object of the invention to provide an elevator door with an improved door panel guidance.

The object is fulfilled by an elevator door with a door sill having a guide groove with two mutually spaced side walls, and a door panel which is movable along the guide groove and at the door panel terminations of which facing the door sill a guide shoe entering the guide groove is arranged, wherein the guide shoe is arranged at the first end of the door panel termination facing the door opening when the elevator door is open and the side walls of the door sill are formed as guide surfaces for the guide shoe, wherein the door panel has at the door panel termination a guide straight edge extending along the door panel termination and the door sill has a guide body, wherein the guide body forms at least one guide surface for guidance of the guide straight edge.

The door sill of an elevator door serves as a tread region below the door opening for elevator passengers when entering and departing from the elevator car. In addition, the door sill is used in order to guide or mount the door panel at its door panel termination facing the door sill, i.e. at its lower edge.

When the elevator door is closed the door panel is exposed substantially along the entire length thereof to potential external action, for example by an elevator passenger. Elevator passengers can cause such an external action by, for example, leaning against the closed floor door or car door. Correspondingly, when the car door is closed it is necessary to mount the door panel on the door sill at both ends of the door panel lower edge so as to avoid any outward pivotation of the door panel if external action occurs.

The invention is based on the recognition that during opening or closing of the elevator door and the accompanying displacement of the door panel only the part of the door panel, which is freely accessible from the elevator car or the floor, in the region of the door opening can be exposed to external action by elevator passengers.

Accordingly, it is sought to create a shortened door sill which ensures sufficient guidance of the door panel. This is achieved by the fact that a first point of the mounting of the door panel, thus the guide shoe, is fixedly arranged at the first end, which faces the door opening when the elevator door is open, of the door panel lower edge. The guide shoe in that case represents a mobile carriage guided along the guide groove formed as a guide track.

A second point of the mounting of the door panel is arranged at the door sill to be movable relative to the door panel lower edge. The movability of the said second point is achieved by guidance of the guide straight edge, which is arranged in the door panel, at the guide body belonging to the door sill. The guide body here represents a further carriage, which is arranged at the door sill and which serves for guidance of the door panel at the guide straight edge formed as a guide track. Thus, at these two points substantially only the freely accessible part of the door panel is guided or mounted at its lower edge in the door sill.

In addition, an enhanced stability of the freely accessible region of the door panel is advantageous in such a door panel guidance, because substantially this freely accessible region of the door panel is mounted at all times at both of its outer ends of the door panel termination facing the door sill. A further advantage results from the fact that an elevator shaft in which an elevator car with this elevator door is arranged to be movable along its travel path can be provided with appropriately smaller dimensions along this movement path.

In a development of the elevator door the guide body is arranged in the guide groove. Thus, the guide body can be supported against the side walls of the guide grooves: the stability of the side walls of the guide groove can thus be employed if an external action on the door panel is present. In this way it is possible to dispense with reinforcement of the guide body, which is provided for acceptance of forces resulting from such external actions.

In a development, the guide body is arranged at the door sill to be movable parallelly to or along the guide groove. In this way, such a door panel guidance can be used on more rapid door panels belonging to a telescopic door. The guide body can comprise a roller element having the guide surface, wherein the roller element is rollable along the door sill. A movable guide body can be realized in this manner.

In a development of the elevator door the guide body is attached to the door sill. A simple, robust door panel guidance having few movable parts is thus made possible. Contaminations at the door sill are thus less risky with respect to the functionality of the door panel guidance.

In a development of the elevator door the guide straight edge is formed to be substantially continuous between the guide shoe and the second end of the door panel termination facing away from the door opening when the elevator door is open. In that way the entire door panel termination facing the door sill can be used for guidance of the door panel. A maximum length of the guide straight edge permits a minimum length of the door sill beyond the boundary of the door opening.

In a development of the elevator door the guide surface is formed as a rolling or sliding surface. A construction of the guide surface of the guide body in that manner allows realization of lowest possible friction between the guide straight edge and the guide body.

In a development of the elevator door the guide straight edge enters the guide groove. Here it is of advantage that the flat plane, which is visible to the elevator passengers, of the door panel can extend up to the door sill. Thus, there is no excessively wide gap, which could lead to an increased risk with respect to injuries for elevator passengers, between this flat door panel plane and the door sill.

In a development of the elevator door the guide body is spaced from a guide groove base. In door sills of elevator doors it is important, in order to guarantee a permanent capability of functioning, that contaminations do not collect in the guide groove. Such a constructional measure permits the guide body to additionally be arranged at the door sill without this having the consequence of increased dirtying of the guide groove.

In a development of the elevator door the guide surface of the guide body forms a maximum length of 10 centimeters parallel to or along the guide groove. Excessive friction of the guide surface at the guide straight edge can be avoided in that manner.

### DESCRIPTION OF THE DRAWINGS

The invention is explained in more detail in the following by way of figures, in which:

FIG. 1 shows an elevator door according to the prior art;

FIG. 2 shows a lower region of an elevator door according to a first variant of embodiment;

FIG. 3 shows the lower region of the elevator door of FIG. 2 in cross-section;

FIG. 4 shows the lower region of the elevator door of FIG. 2 in a further cross-section;

FIG. 5 shows a lower region of an elevator door according to a second variant of embodiment in the closed state; and

FIG. 6 shows the elevator door according to FIG. 5 in the open state.

### DETAILED DESCRIPTION

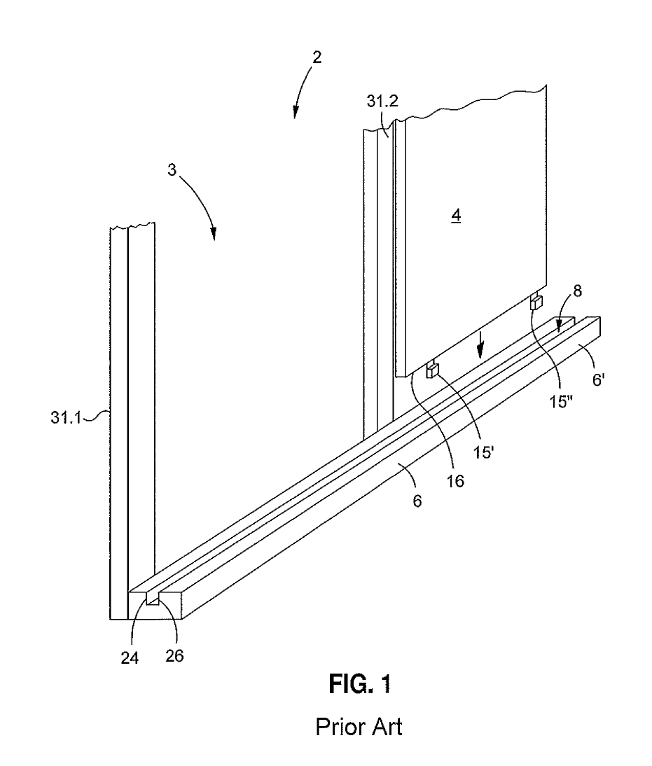

FIG. 1 shows an elevator door 2 having a door panel guide according to the prior art. The elevator door 2 comprises a door panel 4 and a door sill 6. In the closed state of the elevator door 2 the door panel 4 covers at least a part of the door opening 3, which can be bounded at each of the two sides by a respective door post 31.1 or 31.2. The door panel 4 is guided in the door sill 6 in the region of a door panel termination 16 facing the door sill 6. On the one hand the door sill 6 has for this purpose a guide groove 8. On the other hand, a first guide shoe 15′ and a second guide shoe 15″ are attached to the door panel termination 16 of the door panel 4.

The guide shoes 15′, 15″ attached to the door panel 4 enter the guide groove 8 of the door sill 6. In order to be able to guide both guide shoes 15′, 15″ in the guide groove 8 at all times up to the fully open state of the elevator door 2 a door sill 6 has a door sill extension 6′. Unlike the door sill 6 arranged below the door opening 3, the door sill extension 6′ does not serve as a step area for elevator passengers.

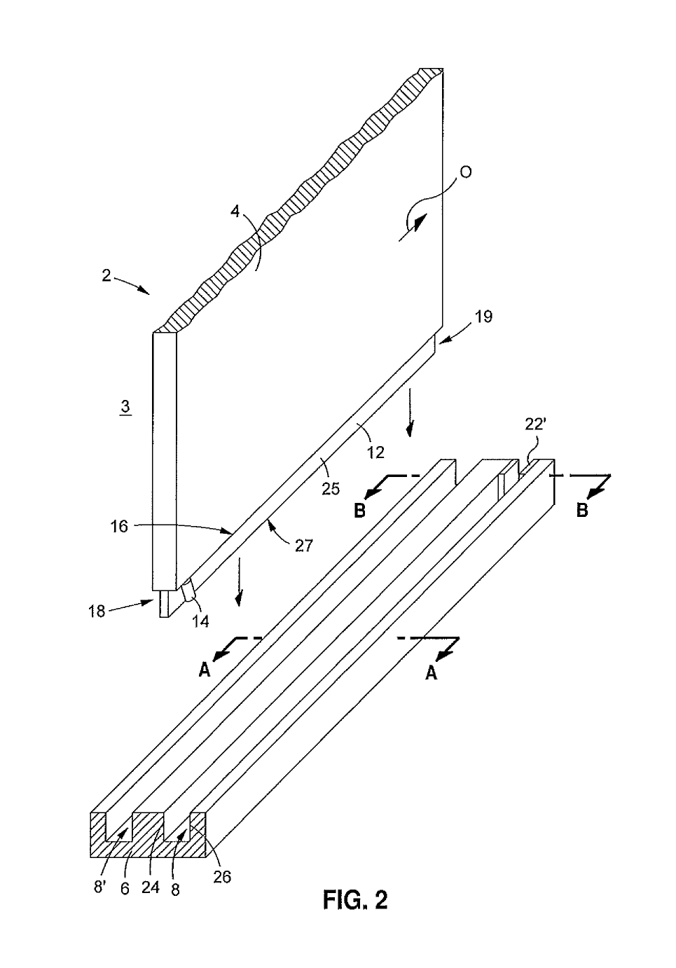

FIG. 2 shows a lower region of an elevator door 2. The elevator door 2 is shown in an exploded illustration in the closed setting according to a first variant of embodiment. The elevator door 2 comprises a door panel 4 and a door sill 6. In the closed setting, the door panel 4 covers a door opening 3 at least partly. The door panel 4 has a door panel termination 16 which faces the door sill 6. A guide shoe 14 and a guide straight edge 12 are arranged at the door panel termination 16. The guide shoe 14 is arranged at the first end 18, which faces the door opening 3 when the door 2 is completely open, of the door panel termination 16. The door sill 6 has a guide groove 8 for guidance of the elevator door panel 4. The door sill 6 can have a further guide groove 8′ for guidance of a further door panel (not illustrated). The guide groove 8 has two side walls 24 and 26. The guide shoe 14 enters the guide groove 8 and during opening or closing movement of the elevator door is guided at the side walls 24 and 26 thereof. For example, the guide shoe 14 can be slidably guided at the side walls 24 and 26.

The guide straight edge 12 can enter the guide groove 8 of the door sill 6 just like guide shoe 14. The guide straight edge 12 can be formed to be continuous substantially between the guide shoe 14 and the second end 19, which is remote from the door opening 3 when the elevator door 2 is open, of the door panel termination 16. The guide straight edge 12 has a first panel wall 25 and a second panel wall 27. The side walls 24 and 26 of the guide groove 8 are spaced from the panel walls 25 and 27 of the guide straight edge 12 in such a manner that the guide groove 8 is not suitable as a guide for the guide straight edge 12.

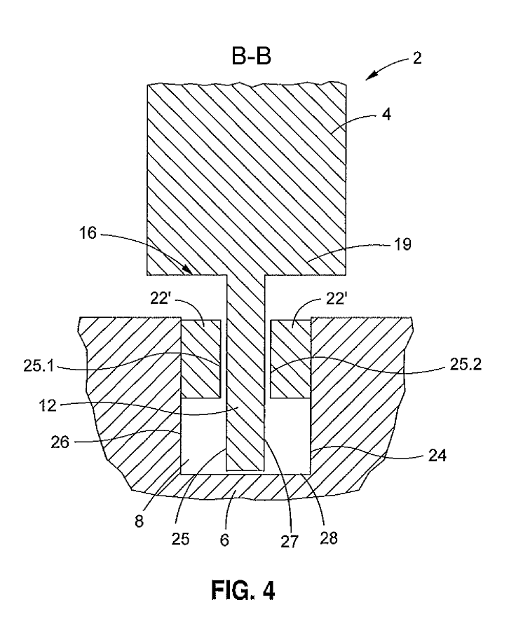

A guide body 22′ is attached to the door sill 6, for example at and/or in the guide groove 8. The guide body 22′ has at least one guide surface, which is not illustrated (see FIG. 4), constructed for guidance of the guide straight edge 12. This guide surface can be constructed as a rolling or sliding surface, wherein the guide surface formed in this way rolls or slides along the associated side wall 25 or 27 of the guide straight edge during door movement. When the elevator door 2 is open, the guide shoe 14 is arranged near the guide body 22′.

FIG. 4 shows a cross-section B-B of the elevator door 2 illustrated in FIG. 2. The guide shoe, which is arranged at the door panel termination 16, for guidance of the door panel 4 in the guide groove 8 is not illustrated. The guide groove 8 of the door sill 6 has, additionally to the side walls 24 and 26, a guide groove base 28. The guide body 22′ attached to the door sill 6 can be spaced from the guide groove base 28 so that removal of contaminations from the guide groove 8 by means of simple devices is facilitated. Such a device cleaning the guide groove 8 can be constructed, for example, at the guide shoe in the form of a brush.

The guide body 22′ has at least one guide surface 25.1, 25.2 for guidance of a panel wall 25, 27 associated therewith of the guide straight edge 12. The guide surface 25.1, 25,2 is spaced from the panel wall 25, 27 associated therewith in correspondence with this guidance function. This means that the panel wall 25, 27 of the guide straight edge 12 is guidable by the guide surface 25.1, 25.2 associated therewith of the guide body 22′, but nevertheless there is no excessive friction between the panel wall 25, 27 and the guide surface 25.1, 25.2 associated therewith. Thus, the guide surface 25.1, 25.2 can have, for example, a maximum length of 10 centimeters along or parallel to the guide groove 8.

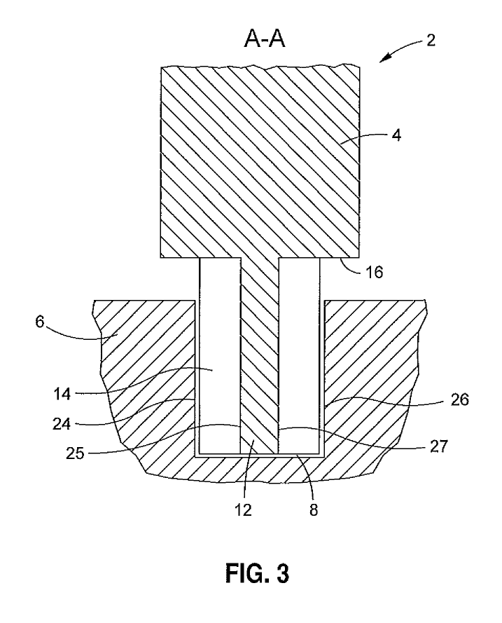

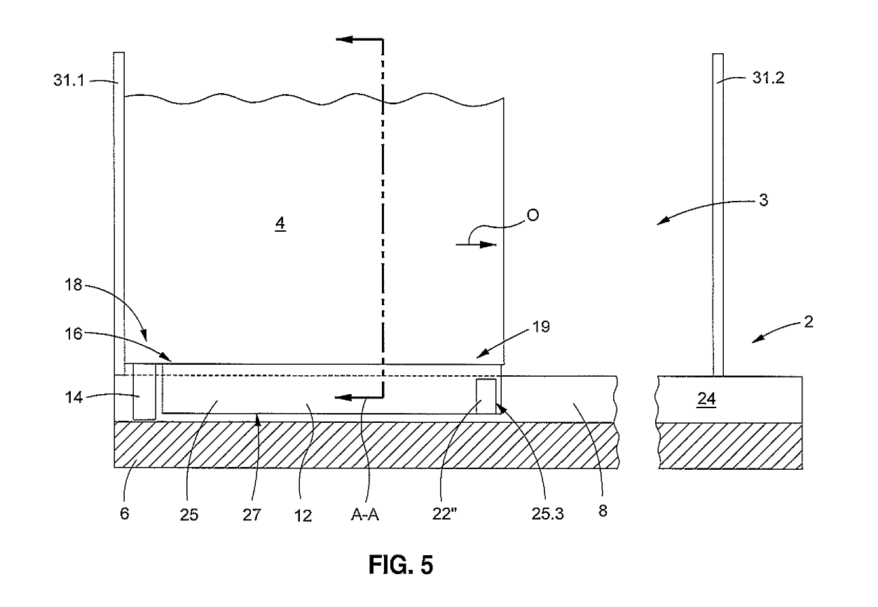

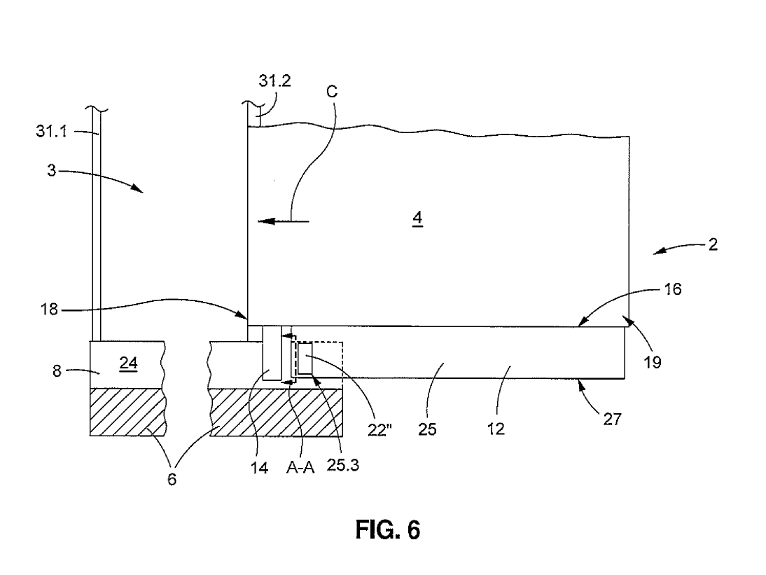

FIG. 3 shows a cross-section A-A of the elevator door 2 illustrated in FIG. 2, which similarly serves as a cross-section for the second variant of embodiment of the elevator door 2 illustrated in FIGS. 5 and 6. The door sill 6 has a guide groove 8 for guidance of the door panel 4. The guide groove 8 has two side walls 24 and 26. The guide shoe 14 enters the guide groove 8 and is guided during opening and closing movement of the elevator door at the side walls 24 and 26 of the guide groove. The guide shoe 14 can, for example, be slidably guided at the side walls 24 and 26. The guide straight edge 12 can, just like the guide shoe 14, enter the guide groove 8 of the door sill 6. The guide straight edge 12 has a first panel wall 25 and a second panel wall 27. The side walls 24 and 26 of the guide groove 8 are spaced from the panel walls 25 and 27 of the guide straight edge 12 in such a manner that the guide groove 8 for the guide straight edge 12 is not suitable as a guide.

FIGS. 5 and 6 show a lower region of an elevator door 2 according to a second variant of embodiment. The elevator door 2 is shown in both the closed setting (FIG. 5) and the opened setting (FIG. 6). The door panel 4 in the closed setting at least partly covers the door opening 3. The door opening 3 is laterally bounded by, for example, door opening boundary elements 31.1 and 31.2. The guide shoe 14 arranged at the door panel 4 is arranged at the first end 18, which faces the door opening 3 when the elevator door 2 is fully open, of the door panel termination 16. The guide straight edge 12 is, for example, formed to be continuous between the guide shoe 14 and the second end 19, which is remote from the door opening 3 when the elevator door 2 is open, of the door panel termination 16. The door sill 6 comprises a guide body 22″ which can be movably arranged at the door sill 6, for example in the guide groove 8.

The guide body 22″ has at least one guide surface 25.3, which is associated with the panel wall 25, 27 of the guide straight edge 12, for guidance of the guide straight edge 12. The guide surface 25.3 can be a component of a roller element (not illustrated) of the guide body 22″. The roller element with the guide surface 25.3 can be formed between the guide straight edge 12 and one of the two side walls 24 and 26 of the guide groove 8. When the elevator door 2 is in the open setting (FIG. 6) the guide body 22″ with the guide surface 25.3 at the guide straight edge 12 is arranged at a first end, which faces the guide shoe 14, of the guide straight edge 12.

In the case of a door movement indicated in FIGS. 2, 5 and 6, i.e. an opening movement O or a closing movement C of the elevator door 2, the door panel 4 is moved along the guide groove 8 and the guide shoe 14 is guided by means of the side walls 24 and 26 of the guide groove 8. The panel walls 25 and 27 of the guide straight edge 12 are spaced from the side walls 24 and 26 of the guide groove 8 so that the guide straight edge 12 cannot be guided by the side walls 24 and 26. In this way excessive friction between the door panel 4 and the side walls 24 and 26 of the guide groove 8 is prevented. The guide body 22′, 22″ arranged at the door sill 6 serves for guidance of the guide straight edge during the door movement O, C. During the opening movement P and also closing movement C the guide shoe 14 is guided at the side walls 24 and 26 of the guide groove 8 and the guide straight edge 12 at the at least one guide surface 25.1, 25.2, 25.3 of the guide body 22′, 22″. When the elevator door 2 is open, the guide shoe 14 can be arranged in the immediate vicinity of the guide body 22′.

During a closing movement of the elevator door 2 illustrated in FIG. 6 the guide body 22″ is moved along the guide groove 8. For example, the roller element of the guide body 22″ rolls not only at the guide straight edge 12, but also at the corresponding side wall 24, 26 of the guide groove 8. The same applies in converse sense for the opening movement O of the elevator door 2 (FIG. 5). As a consequence thereof the guide body 22″ in the closed setting of the elevator door 2 can be arranged at the guide straight edge 12 at a second end, which is remote from the door opening 3 when the elevator door 2 is open, of the guide straight edge 12.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator door including a door sill having a guide groove formed therein with two mutually spaced side walls and a door panel which is movable along the guide groove and has a termination at which a guide shoe is arranged facing the door sill and entering the guide groove, wherein the guide shoe is arranged at a first end of the door panel termination which faces a door opening when the elevator door is open, and the side walls of the door sill guide groove are formed as guide surfaces for the guide shoe, comprising:
the door panel having a door panel termination with a guide straight edge extending along the door panel termination; and
the door sill having a guide body, wherein the guide body forms at least one guide surface for guidance of the guide straight edge as the door panel is moved to open and close the door opening.

2. The elevator door according to claim 1 wherein the guide body is arranged in the guide groove.

3. The elevator door according to claim 1 wherein the guide body is arranged at the door sill to be movable parallel to or along the guide groove.

4. The elevator door according to claim 3 wherein the guide body comprises a rolling element having a guide surface, and wherein the rolling element is rollable along the door sill.

5. The elevator door according to claim 1 wherein the guide body is attached to the door sill.

6. The elevator door according to claim 1 wherein the guide straight edge is substantially continuous between the guide shoe and a second end of the door panel termination that is remote from the door opening when the elevator door is open.

7. The elevator door according to claim 1 wherein the at least one guide surface is constructed as a rolling surface or slide surface.

8. The elevator door according to claim 1 wherein the guide straight edge enters the guide groove.

9. The elevator door according to claim 1 wherein the guide body is spaced from a base of the guide groove.

10. The elevator door according to claim 1 wherein the guide surface of the guide body forms a maximum length of 10 centimeters parallel to or along the guide groove.

11. An elevator door comprising:
a door sill in an elevator door opening and having a guide groove formed therein with two mutually spaced side walls;
a door panel which is movable along the guide groove and having a termination facing the door sill;
a guide shoe arranged at the door panel termination and entering the guide groove, wherein the guide shoe is arranged at a first end of the door panel termination which faces the door opening when the elevator door is open, and the side walls of the door sill guide groove are formed as guide surfaces for the guide shoe;
a guide straight edge extending along the door panel termination; and
a guide body arranged at the door sill, wherein the guide body forms at least one guide surface for guidance of the guide straight edge as the door panel is moved to open and close the door opening.
